(19) United States
(12) Patent Application Publication
(10) Pub. No.: US 2005/0112392 A1
(43) Pub. Date: May 26, 2005

(54) Film with improved antiblocking and adhesion properties

(75) Inventor: Andrew Wilkie, Avondale, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Applied Extrusion Technologies, Inc., New Castle, DE (US)

(21) Appl. No.: 10/980,715

(22) Filed: Nov. 3, 2004

Related U.S. Application Data
(60) Provisional application No. 60/520,721, filed on Nov. 17, 2003.

(51) Int. Cl. B32B 27/08

(52) U.S. Cl. 428/516

(57) ABSTRACT

A multilayer plastic film includes a core layer and opposed skin layers. One of the skin layers includes a blend of more than 50% by weight high-density ethylene polymer and less than 50% by weight of a polar polymer. This blended skin layer is sufficiently active to bond to an extruded, heat-sealable layer of a polar, ionomer resin with an effective bond strength and without a primer between the skin layer and ionomer resin. A metal layer preferably is included on the other skin layer.

### RELATED APPLICATION

This is a non-provisional application of provisional application Ser. No. 60/520,721, titled “Film with Improved Antiblocking Properties” filed on Nov. 17, 2003, the subject matter of which is incorporated by reference herein.

### FIELD OF THE INVENTION

This invention relates generally to polyolefin films, and more specifically to polyolefin films intended to be metallized and having desirable adhesion properties.

### BACKGROUND ART

Prior art metallized films include a polypropylene homopolymer core, an ethylene propylene random copolymer skin layer on one side thereof, for receiving a metallized layer thereon, and a polypropylene homopolymer skin layer on the opposed side of the core which is oxidatively treated to render it suitable for receiving either a bonding material or a printing ink thereon. The surface containing the propylene ethylene random copolymer likewise is oxidatively treated; preferably by flame treatment, to render this surface sufficiently aggressive to receive and retain the metallized layer thereon.

In the above-identified prior art films, the polypropylene homopolymer skin layer, which is flame treated to be receptive to adhesives and printing inks, also includes an anti-block agent, such as Tospearl available from Toshiba Company, to improve, or reduce the coefficient of friction of the laminate, and also synthetic silica as an anti-block additive.

To the best of Applicant's knowledge, it has not been possible in the above-identified prior art films to add a sufficient quantity of an anti-block and slip agent to eliminate the blocking problem; particularly in high temperature, high humidity conditions (e.g., such as in summer months when factory conditions are hot, and/or in manufacturing facilities in the southern states).

As should be understood, the opposed skin layers of prior art films are oxidatively treated, generally by flame treatment or corona treatment, to render these surfaces “aggressive.” That is, one surface must be capable of tenaciously receiving and holding a metallized layer thereon, and the opposed surface must be capable of tenaciously receiving either a bondable layer or printing ink thereon.

Unfortunately, the creation of these aggressive surfaces tends to cause the film to block, i.e., the inside surface adheres to the outside surface when wound into a roll, such as when the film is wound up at the end of the initial formation of the coextruded film or when the film is wound up at the end of a slitting operation in which the film is slit into desired widths.

A further problem encountered with the above-identified prior art film is that the polypropylene homopolymer skin layer does not have sufficient aggressiveness for receiving either a polyethylene heat-sealable layer thereon, or a Surlyn heat-sealable layer thereon. Surlyn is a trademark of The Dupont Company for a zinc or sodium ionomer of an ethylene/methacrylic acid copolymer. Surlyn provides a better bond strength than a polyethylene by itself, to thereby achieve more robust hermetic seals for packages that must be transported over high elevations.

Another prior art product on the market has been determined to have reasonably good retention properties to a polyethylene, heat-sealable layer. In this latter product, the layer for receiving the adhesive thereon is a polyethylene layer formed as part of the coextruded product. Applicant does not know whether this polyethylene layer is either a homopolymer or copolymer polyethylene. The opposed skin layer is a polyethylene homopolymer for receiving a metallized layer thereon. The polyethylene skin layer for receiving the metallized layer thereon is flame treated. However, applicant does not know whether the surface of the polyethylene layer for receiving the adhesive thereon is either flame treated or corona treated.

U.S. Pat. No. 5,194,318, issued to Migliorini et al., discloses the use of a high density polyethylene, flame-treated surface for metallization.

U.S. Pat. No. 6,287,700, issued to Kong et al., generally discloses the use of a polyethylene material as a bonding layer, with only a minor percentage of the polyethylene being a high density polyethylene (column 3, paragraph beginning on line 7).

U.S. Pat. No. 5,981,047 discloses a matte finished biaxially oriented polypropylene film for cold seal release applications, which was invented by the inventor of the instant invention. In this patent, in column 8, numerous possible combinations of polymers and additives are disclosed for use as a cold seal receptive layer. The number of combinations and permeations possible in a composition blended with a functionally modified polyolefin or a polar polymer additive is exceptionally large. One possible combination is a high-density polyethylene blended with polar polymers containing acrylic or methacrylate acid in a quantity sufficient to enhance adhesion of the cold seal composition to the skin surface. In view of the excessively large number of possible combinations, the actual selection of high-density polyethylene and a polar additive to achieve the benefits of the present invention with a heat-sealable layer simply is not taught to a person skilled in the art.

It has been determined that the above-identified prior art product including opposed, oxidatively treated polyethylene skin layers has a bond strength to an extrusion coated polyethylene, heat-sealable layer of about 500 gm/in, as compared to a bond strength of about 200 gm/in in the earlier-described prior art metallized film employing a C₃ homopolymer for receiving the heat-sealable layer thereon.

However, even with the film employing opposed, oxidatively treated polyethylene skin layers, when it is desired to employ Surlyn as the heat-sealing layer attached to the polyethylene skin layer, the skin layer must be primed in order to obtain desirable bond strength. In fact, without the use of a primer, the Surlyn has bond strength of about 60 gm/in to the polyethylene skin layer, as compared to bond strength of about 20 gm/in when the Surlyn is bonded to the polypropylene homopolymer of the first-identified prior art metallized film. When both of the earlier-described prior art products are primed and Surlyn is extrusion coated thereon, bond strengths of about 200-400 gm/in are achieved.

It should be understood that the above-described, prior art metallized films are employed in, what is referred to as a “pouch structure.” Prior to the use of these films, a pouch structure included the following layers, in sequence:
(1) A surface printed and overlaquered paper layer;
(2) An extruded polyethylene adhesive layer;
(3) an aluminum foil barrier layer; and,
(4) a Surlyn extruded, heat seal layer on the foil layer.

The above-identified prior art coextruded metallized films replace the aluminum foil layer in the above-described pouch structure to provide several benefits. In particular, the aluminum foil barrier layer is quite expensive as compared to a metallized BOPP film; and actually more expensive than the thin metallized film that is substituted for it. Second, there are environmental benefits, since the foil employed previously is relatively thick, compared to a very thin, (e.g., typically 50-500 nanometers) metallized layer forming part of the coextruded metallized film. Third, although the barrier properties of the unflexed aluminum foil layer are generally superior to that of unflexed metallized BOPP film, the handling of the foil layer causes it to crinkle and develop pinholes to thereby adversely affect the barrier properties. In fact, after handling, the barrier properties of the metallized BOPP film are far superior to the aluminum foil. Thus, replacing the aluminum foil with a coextruded metallized BOPP film in the above-identified pouch structure has benefits of economics, disposability and packaged product shelf life.

It should be noted that when the initially formed coextruded film is sold to a converter, the converter typically primes the film surface that receives the extrusion coating of Surlyn thereon (if priming is required), but not the opposed surface for receiving the metallized layer thereon. It would be highly desirable to achieve a superior bond of the film to Surlyn without the need to utilize a primer. As noted earlier, in order for either the earlier-described prior art films to adequately adhere to Surlyn, a primer is required. In particular, without the primer a bond strength only in the range of 20-60 gm/in was achieved, whereas the primed products achieve bond strengths of about 200-400 grams/in.

### SUMMARY OF THE INVENTION

A multilayer plastic film in accordance with this invention includes a core layer and opposed skin layers, one of said skin layers including a blend of more than 50% by weight of the skin layer of a high-density ethylene polymer and less than 50% by weight of the skin layer of a polar polymer, said one of said skin layers being sufficiently active to effectively bond to an extruded, heat-sealable layer of a polar, ionomer resin without a primer between said skin layer and ionomer resin. Preferably the bond strength is in excess of 200 grams/inch; more preferably in excess of 600 grams/inch, and even more preferably in excess of 1000 grams/inch. More preferably, the high density ethylene polymer is present in an amount of at least 75% by weight of the skin layer and the polar polymer is present in an amount of no more than 25% by weight of the skin layer of a polar polymer. Even more preferably the high density ethylene polymer is present in an amount of more than 75% % by weight of the skin layer and the polar polymer is present in an amount of less than 25% by weight of the skin layer of a polar polymer. Still more preferably the high density ethylene polymer is present in an amount of at least 87.5% by weight of the skin layer and the polar polymer is present in an amount of no more than 12.5% by weight of the skin layer of a polar polymer. Even more preferably the high density ethylene polymer is present in an amount of more than 90% by weight of the skin layer and the polar polymer is present in an amount of less than 10% by weight of the skin layer of a polar polymer.

In a preferred embodiment, a heat-sealable layer of a polar, ionomer resin is included on the skin layer that includes a blend of the high-density ethylene polymer and the polar polymer. In the most preferred embodiments, a metal layer is provided on the opposite skin layer.

Most preferably, the polar modified component of the bonding layer is a functionally modified ethylene copolymer. More preferably the functionally modified ethylene copolymer is an acid modified ethylene acrylate and, for some applications, also can be an ethylene methyl acrylate.

In the preferred embodiments of this invention the high density ethylene polymer should be of a low viscosity; preferably having a melt index of greater than 0.5 g/10 minutes, more preferably at least 2.0 g/10 minutes and even more preferably at least 5.0 g/10 minutes.

### PREFERRED EMBODIMENTS OF THE INVENTION

In accordance with this invention, a coextruded plastic film preferably is biaxially oriented in conventional tenter or bubble extrusion forming devices. Preferably the coextruded plastic film can be formed on a Linear Speed Induction Motor (LSIM). As is known in the art, in an LSIM simultaneous biaxial orientation takes place in the tenter oven thereby eliminating the need for a separate machine direction orientation unit. Therefore, in an LSIM the web does not come in contact with heated chrome rolls to effect orientation. However, the vast majority of BOPP orientation equipment in the world is sequential tenter lines. The coextruded plastic film of this invention includes a core layer and opposed skin layers, one of said skin layers being highly receptive to, and providing excellent bond strength with a heat-sealable layer of a polar resin, and in particular a zinc or sodium ionomer of an ethylene/methacrylic acid copolymer such as is sold under the trademark Surlyn by The Dupont Company, without the need for utilizing a separate primer.

In particular, the film of this invention employs a high-density ethylene polymer blended with a polar component to render the outer layer sufficiently active to achieve an effective bond to a extruded, heat-sealable layer of the polar Surlyn ionomer resin without the use of a separate primer between the film and the ionomer resin.

Preferably the high-density ethylene polymer used in this invention should have a density of at least 0.93 g/cc and even more preferably 0.945 g/cc or greater. Most preferably, the high-density ethylene polymer utilized in this invention should be of a low viscosity having a melt index greater than 0.5 g/10 minutes, more preferably of at least 2.0 g/10 minutes and even more preferably of at least 5.0 g/10 minutes. A preferred high-density ethylene polymer employed in this invention is Finathene 6450 manufactured by Atofina Petrochemicals Inc. of Houston Tex. and having a density of 0.945 g/cc and a melt index of 5.0 g/10 min. A polyethylene having a melt index of 0.45 g/10 min. was found to have a viscosity that was too high, it was difficult to process through the extruder and resulted in flow related defects in the film.

Other high-density ethylene polymers can be employed in this invention, as would be apparent to people skilled in the art, it being understood that people skilled in the art understand that high density polyethylene (HDPE) is defined as having a density between 0.934-0.97 g/cc, approximately 80% crystallinity and a melting point range of approximately 125-135° C. HDPE's typically contain a very small amount (<3%) of butene or hexane comonomer and have very little side chain branching. HDPE is most preferred in this application because of its relatively high melting point compared to lower density/lower melting point medium, low and linear low density polyethylene resins to prevent sticking on the machine direction orientation rolls of a conventional tenter line. Fabricating the biaxially oriented polypropylene (BOPP) film on a tubular line would allow for running a lower density/lower melting point polyethylene because the polymer does not come in contact with hot melt surfaces during orientation.

Reference throughout this application to an “ethylene polymer” means ethylene homopolymers, ethylene copolymers including more than 50% ethylene in them and blends of such homopolymers and copolymers, unless specifically indicated otherwise.

Most preferably the polar component blended with the high-density polyethylene is a functionally modified ethylene copolymer and most preferably an acid modified ethylene acrylate, although for some applications other polar additives may be used, such as ethylene methyl acrylate (EMA). However, based on the research effort to date, it has been determined that the properties achieved with the acid modified ethylene acrylate are superior to those achieved with the ethylene methyl acrylate. A representative acid modified ethylene acrylate usable in this invention is Bynel CXA 2014 manufactured by DuPont located in Wilmington, Del. A representative ethylene methyl acrylate usable in this invention is Optema TC 020 manufactured by ExxonMobil, located in Houston, Tex. Other acid modified ethylene acrylates and ethylene methyl acrylates may be employed in this invention.

In a pilot test employing a 58%-42% blend, by weight, of a high-density polyethylene homopolymer (i.e., Finathene 7208, having a density of 0.959 g/cc and a melt index of 0.45 g/10 min made by Atofina Petrochemicals, Inc. located in Houston Tex.) and an acid modified ethylene acrylate (i.e., DuPont Bynel CXA 2014 manufactured by DuPont) as the functional polymer, respectively, the bond strength to Surlyn, without the use of a primer, was in excess of 1,000 grams/in. In distinction, a control product employing a flame-treated polypropylene homopolymer skin onto which a layer of Surlyn was extruded had a bond strength of only 20 grams/in.

It should be noted that the 58%-42% blend was corona treated to enhance the aggressiveness for the Surlyn layer, but no primer was employed. In distinction to the results on the pilot line, the earlier-described prior art product employing polyethylene skin layers, without a primer, had a bond strength to the Surlyn sealant of about 60 grams/in.

Thus, the unprimed product of the present invention had a bond strength more than 10 fold (i.e., more than 600 grams/in) the bond strength achieved with the unprimed prior art product (i.e., about 60 grams/in) employing a flame treated or corona treated polyethylene skin layer for receiving the extruded, Surlyn layer.

It was determined that the use of a blend of 58% high-density polyethylene and 42% of an acid modified ethylene acrylate, while providing excellent bond strength, did exhibit metal pickoff from the opposed surface, when the metallized layer was wound into a roll. This is believed to be the result of the functionally modified ethylene resin having a strong affinity for the metal on the opposite side of the film, particularly just after metallization when the metal and film are warm (˜90-100° F.).

In a subsequent production line test the percentage of the functional, polar component, in the form of the earlier-identified acid modified ethylene, was reduced to 25%. In addition, testing was conducted by running, as a control, a coextruded product having a high-density polyethylene skin layer, by itself (i.e., without any functional group). However, the high-density polyethylene selected for testing, Finathene 7208, had too high a viscosity (i.e., a melt index of <0.5 g/10 min), which caused it to run poorly through the extruder and resulted in a film with poor visual quality. By adding a functional component, e.g., a functional polymer of lower viscosity (e.g., an acid modified ethylene acrylate) the polymer blend ran reasonably well through the extruder; resulting in the formation of a coextruded film. In selecting the functional component added to the high-density polyethylene consideration was given to the temperature at which it might decompose, and the functional component selected did not decompose at a temperature reaching 280° C. The reason for this consideration is that at least a portion of the blend of high-density polyethylene and the functional polymer is chopped up and used as recycle in the core layer of the film being manufactured. The core layer of the film can reach temperatures in excess of 280° C., and therefore, when the reclaim material is introduced into the core, it will be exposed to these high temperatures. It is important that the functionally modified copolymer component not decompose when exposed to such high temperatures in the section of the extrusion process from which the core layer is formed.

It was determined that a product having a bonding skin layer opposite the metallizable surface of the film composed of a high-density polyethylene and 25% of the acid modified ethylene acrylate did unwind, without significant problems. The slit roll also unwound well in films that did not have a metallized layer thereon.

In a further test employing ethylene methyl acrylate (EMA) (Elvaloy 1609 AC manufactured by DuPont) as the polar functional component blended at 25 wt % with a lower viscosity high-density polyethylene (Atofina 6450, 0.96 g/cc, melt index of 5.0 g/10 min, manufactured by Atofina Petrochemicals, Inc.), the co-extruded film processed without difficulty, except the surface of the blended layer adhered to the heated chrome roll employed in the machine direction orientation (MDO) operation. In other words, a portion of the polymer blend skin layer was separated from the main body of the film by the hot machine direction orientation rolls. This phenomenon of polymer lifting was determined to exist with both functional polymers; namely, the acid modified ethylene acrylate polymer and the ethylene methyl acrylate polymer.

As a result of this testing the amount of the acid modified ethylene acrylate terpolymer (i.e., acid modified-EA) was reduced from 25% to 12.5 wt %, and employed with the low viscosity (i.e., higher melt index), high-density polyethylene previously employed with the EMA (Atofina 6450). This product ran well out of the extruder and also fairly well through the machine-direction-orientation (MDO), chrome roll. Although there were some deposits, they were not nearly as severe as occurred when the skin layer blend included 25% of the functional component.

The customer was satisfied with the basic properties of the product including the 12.5% acid-modified EA. However, EMA resin, at the 25 wt % level, appeared to be too aggressive with the MDO chrome rolls, in terms of adhesion. Moreover, the EMA resin, at this latter level, did not provide as strong of a bond to the Surlyn as the blend employing 12.5 wt % acid-modified EA, based on several pilot coater lamination trials.

Based on the above test results, two additional runs were conducted, one with the high-density polyethylene by itself (Atofina 6450), and the other with a blend of the high-density polyethylene and 6 wt % of the acid modified ethylene acrylate as the functional polymer. This latter run, employing the blend, gave the best results of all of the tested products. In fact, the product ran perfectly, did not stick to the machine direction orientation rolls, unwound easily, and gave excellent barrier properties.

The customer (a converter) of a base roll of metallized co-extruded film employing the blend of 6 wt % acid modified EM and the low viscosity, high density polyethylene (HDPE), extrusion coated the blended layer of the film with a Surlyn polyethylene, heat-sealable layer without using a primer and obtained excellent and effective destruct bond adhesion results.

It has been determined that the bond strength of the Surlyn is not particularly sensitive to the quantity of the acid modified functional group employed with the high-density polyethylene. This was determined in pilot tests wherein effective bonding to Surlyn was obtained with 5%, 15% and 25% of the acid modified functional group. In these tests, the acid modified functional group was ethylene acrylate and the laboratory humidity was controlled at 50%.

Without further elaboration, the foregoing will so fully illustrate my invention that others may, by applying current or future knowledge; readily adopt the same for use under various conditions of service.

1. A multilayer plastic film including a core layer and opposed skin layers, one of said skin layers including a blend of more than 50% by weight of the skin layer of a high-density ethylene polymer and less than 50% by weight of the skin layer of a polar polymer, said one of said skin layers being sufficiently active to effectively bond to an extruded, heat-sealable layer of a polar, ionomer resin without a primer between said skin layer and ionomer resin.

2. The plastic film of claim 1, said one of said skin layers being sufficiently active to bond to an extruded, heat-sealable layer of a polar, ionomer resin with a bond strength in excess of 200 grams/inch without a primer between said skin layer and ionomer resin.

3. The plastic film of claim 1, said one of said skin layers being sufficiently active to bond to an extruded, heat-sealable layer of a polar, ionomer resin with a bond strength in excess of 600 grams/inch without a primer between said skin layer and ionomer resin.

4. The plastic film of claim 1, said one of said skin layers being sufficiently active to bond to an extruded, heat-sealable layer of a polar, ionomer resin with a bond strength in excess of 1000 grams/inch without a primer between said skin layer and ionomer resin.

5. The plastic film of claim 1, including a heat-sealable layer of a polar, ionomer resin on said one of said skin layers.

6. The plastic film of claim 2, including a heat-sealable layer of a polar, ionomer resin on said one of said skin layers.

7. The plastic film of claim 3, including a heat-sealable layer of a polar, ionomer resin on said one of said skin layers.

8. The plastic film of claim 4, including a heat-sealable layer of a polar, ionomer resin on said one of said skin layers.

9. The plastic film of claim 1, wherein said polar polymer is a functionally modified ethylene copolymer.

10. The plastic film of claim 2, wherein said polar polymer is a functionally modified ethylene copolymer.

11. The plastic film of claim 3, wherein said polar polymer is a functionally modified ethylene copolymer.

12. The plastic film of claim 4, wherein said polar polymer is a functionally modified ethylene copolymer.

13. The plastic film of claim 1, wherein said polar polymer is an acid modified ethylene acrylate.

14. The plastic film of claim 2, wherein said polar polymer is an acid modified ethylene acrylate.

15. The plastic film of claim 1, wherein said polar polymer is an ethylene methyl acrylate.

16. The plastic film of claim 2, wherein said polar polymer is an ethylene methyl acrylate.

17. The plastic film of claim 1, wherein said high density ethylene polymer has a melt index of greater than 0.5 g/10 minutes.

18. The plastic film of claim 1, wherein said high density ethylene polymer has a melt index of at least 2.0 g/10 minutes.

19. The plastic film of claim 1, wherein said high density ethylene polymer has a melt index of at least 5.0 g/10 minutes.

20. The plastic film of claim 1, wherein said one of said skin layers includes a blend of at least 75% by weight of the skin layer of a high-density ethylene polymer and no more than 25% by weight of the skin layer of a polar polymer.

21. The plastic film of claim 1, wherein said one of said skin layers includes a blend of more than 75% by weight of the skin layer of a high-density ethylene polymer and less than 25% by weight of the skin layer of a polar polymer.

22. The plastic film of claim 1, wherein said one of said skin layers includes a blend of at least 87.5% by weight of the skin layer of a high-density ethylene polymer and no more than 12.5% by weight of the skin layer of a polar polymer.

23. The plastic film of claim 1, wherein said one of said skin layers includes a blend of more than 90% by weight of the skin layer of a high-density ethylene polymer and less than 10% by weight of the skin layer of a polar polymer.

24. The plastic film of claim 2, wherein said one of said skin layers includes a blend of at least 75% by weight of the skin layer of a high-density ethylene polymer and no more than 25% by weight of the skin layer of a polar polymer.

25. The plastic film of claim 2, wherein said one of said skin layers includes a blend of more than 75% by weight of the skin layer of a high-density ethylene polymer and less than 25% by weight of the skin layer of a polar polymer.

26. The plastic film of claim 2, wherein said one of said skin layers includes a blend of at least 87.5% by weight of the skin layer of a high-density ethylene polymer and no more than 12.5% by weight of the skin layer of a polar polymer.

27. The plastic film of claim 2, wherein said one of said skin layers includes a blend of more than 90% by weight of the skin layer of a high-density ethylene polymer and less than 10% by weight of the skin layer of a polar polymer.

28. The plastic film of claim 3, wherein said one of said skin layers includes a blend of at least 75% by weight of the skin layer of a high-density ethylene polymer and no more than 25% by weight of the skin layer of a polar polymer.

29. The plastic film of claim 3, wherein said one of said skin layers includes a blend of more than 75% by weight of the skin layer of a high-density ethylene polymer and less than 25% by weight of the skin layer of a polar polymer.

30. The plastic film of claim 3, wherein said one of said skin layers includes a blend of at least 87.5% by weight of the skin layer of a high-density ethylene polymer and no more than 12.5% by weight of the skin layer of a polar polymer.

31. The plastic film of claim 3, wherein said one of said skin layers includes a blend of more than 90% by weight of the skin layer of a high-density ethylene polymer and less than 10% by weight of the skin layer of a polar polymer.

32. The plastic film of claim 5, wherein said one of said skin layers includes a blend of at least 75% by weight of the skin layer of a high-density ethylene polymer and no more than 25% by weight of the skin layer of a polar polymer.

33. The plastic film of claim 5, wherein said one of said skin layers includes a blend of more than 75% by weight of the skin layer of a high-density ethylene polymer and less than 25% by weight of the skin layer of a polar polymer.

34. The plastic film of claim 5, wherein said one of said skin layers includes a blend of at least 87.5% by weight of the skin layer of a high-density ethylene polymer and no more than 12.5% by weight of the skin layer of a polar polymer.

35. The plastic film of claim 5, wherein said one of said skin layers includes a blend of more than 90% by weight of the skin layer of a high-density ethylene polymer and less than 10% by weight of the skin layer of a polar polymer.

36. The plastic film of claim 7, wherein said one of said skin layers includes a blend of at least 75% by weight of the skin layer of a high-density ethylene polymer and no more than 25% by weight of the skin layer of a polar polymer.

37. The plastic film of claim 7, wherein said one of said skin layers includes a blend of more than 75% by weight of the skin layer of a high-density ethylene polymer and less than 25% by weight of the skin layer of a polar polymer.

38. The plastic film of claim 7, wherein said one of said skin layers includes a blend of at least 87.5% by weight of the skin layer of a high-density ethylene polymer and no more than 12.5% by weight of the skin layer of a polar polymer.

39. The plastic film of claim 7, wherein said one of said skin layers includes a blend of more than 90% by weight of the skin layer of a high-density ethylene polymer and less than 10% by weight of the skin layer of a polar polymer.

40. The plastic film of claim 1, including a metal layer on the skin layer opposed to said one skin layer.

41. The plastic film of claim 2, including a metal layer on the skin layer opposed to said one skin layer.

42. The plastic film of claim 3, including a metal layer on the skin layer opposed to said one skin layer.

43. The plastic film of claim 5, including a metal layer on the skin layer opposed to said one skin layer.

44. The plastic film of claim 7, including a metal layer on the skin layer opposed to said one skin layer.

45. The plastic film of claim 9, including a metal layer on the skin layer opposed to said one skin layer.
